(19) United States
(12) Patent Application Publication
(10) Pub. No.: US 2011/0109621 A1
(43) Pub. Date: May 12, 2011

(54) System and Method for Designing an Insert Based on a Three Dimensional Image of a Foot

(75) Inventor: Jeffrey E. Schoenfeld, Naples, FL (US)

(73) Assignee: PAL HEALTH TECHNOLOGY, Pekin, IL (US)

(21) Appl. No.: 12/941,478

(22) Filed: Nov. 8, 2010

Related U.S. Application Data
(60) Provisional application No. 61/259,384, filed on Nov. 9, 2009.

(51) Int. Cl. G06T 15/00

(52) U.S. Cl. 345/419

(57) ABSTRACT

In embodiments of the present invention improved capabilities are described for a method and system for designing a support device for a foot. The method and system may include a scanner for obtaining a two-dimensional image of the surface of a foot; an image processing facility for converting the two-dimensional image of the surface of the foot into a three-dimensional map; and a support device design facility for designing a support device based on the foot parameters from the three-dimensional map. The support device design facility is adapted to modify the support device design based at least in part on a foot abnormality.

### CROSS-REFERENCE TO RELATED APPLICATIONS

This application claims the benefit of the following provisional application, which is hereby incorporated by reference in its entirety: U.S. Application No. 61/259,384, filed Nov. 9, 2009.

### BACKGROUND OF THE INVENTION

### Field of the Invention

This invention relates to the field of digital shape acquisition and foot support device design.

### SUMMARY OF THE INVENTION

Disclosure herein relates to systems and methods for foot support device design. In an aspect of the invention, a system for designing a support device for a foot may include a scanner for obtaining a two-dimensional image of the surface of a foot; an image processing facility for converting the two-dimensional image of the surface of the foot into a three-dimensional map; and a support device design facility for designing a support device based on the foot parameters from the three-dimensional map. The support device design facility may be adapted to modify the support device design based at least in part on a foot abnormality. The image processing facility may obtain the three-dimensional map by measuring the color and/or intensity of a pixel of the two-dimensional image and assigning the pixel a distance from the scanner based on its color and/or intensity. The pixel may be a color or grayscale pixel. The system may further include a support device fabrication facility that fabricates the support device based on the support device design generated by the support device design facility.

In an aspect of the invention, a method for designing a support device for a foot may include obtaining a two-dimensional image of the surface of a foot; converting the two-dimensional image of the surface of the foot into a three-dimensional map; and designing a support device based on the foot parameters from the three-dimensional map. The design may be at least partially based on a foot abnormality. Converting the two-dimensional image to a three-dimensional map may include measuring the color and/or intensity of a pixel of the two-dimensional image and assigning the pixel a distance from the scanner based on its color and/or intensity. The pixel may be a color or grayscale pixel. The method may further include fabricating the support device based on the support device design.

These and other systems, methods, objects, features, and advantages of the present invention will be apparent to those skilled in the art from the following detailed description of the preferred embodiment and the drawings. All documents mentioned herein are hereby incorporated in their entirety by reference.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

The invention and the following detailed description of certain embodiments thereof may be understood by reference to the following figures:

FIG. 1 depicts a system for designing a foot support device.

FIG. 2 depicts a logical flow of a method for designing a foot support device.

### DETAILED DESCRIPTION OF THE INVENTION

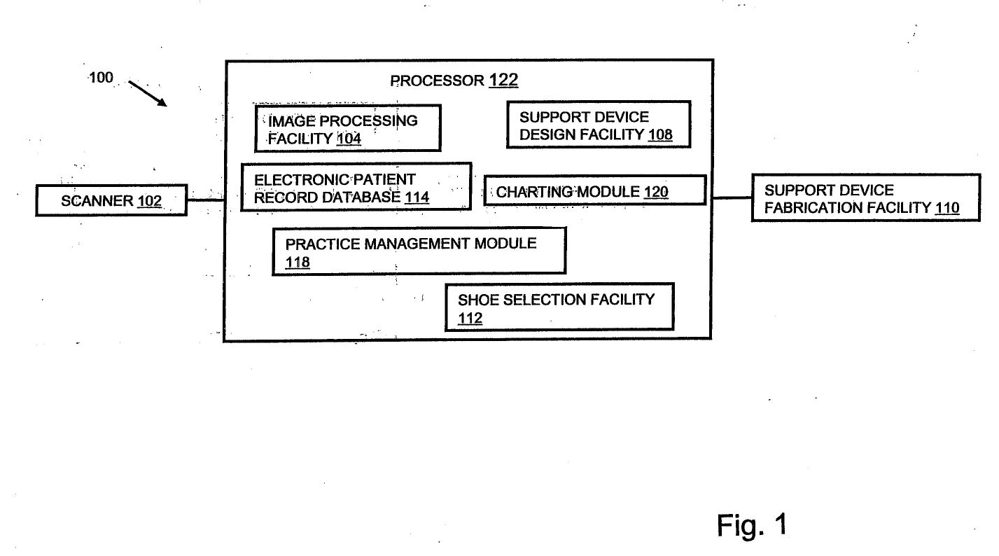

Referring to FIG. 1, a shape acquisition system 100 for designing a support device for a foot may include a scanner 102 for obtaining a two-dimensional image of the plantar surface of a foot, an image processing facility 104 for converting the two-dimensional image of the surface of the foot into a three-dimensional map, and a support device design facility 108 for designing a support device based on the foot parameters from the three-dimensional map. The support device design facility 108 may be adapted to modify the support device design based at least in part on a foot abnormality. The image processing facility 104 and support device design facility 108 may be embodied as software or applications stored on a processor 122 or server associated with the scanner 102.

The shape acquisition system 100 may capture more natural foot shape models in a non-weight bearing format, resulting in a truer foot image and a better orthotic fit. The user may place their left foot, right foot, or both feet on the scanner 102 for obtaining a two-dimensional image of the plantar surface of the foot. A foot support on the scanner 102 may enable non-weight bearing scans of the foot. The scanner may acquire an image of the foot in grayscale, color, black-and-white, and the like. The scanner may optionally be fitted with a larger scanning surface to accommodate larger feet.

The shape acquisition system 100 may also comprise an LCD thermometer as well as pressure sensing devices, which may facilitate diabetic care.

The shape acquisition system 100 may comprise parallel phased array computing, where processors are slaved together and adapted to iteratively process an input shape to determine a match from among a shape library. In embodiments, any body part shape possible thus eliminating the need for costly casting. In embodiments, no human intervention to find a shape match may be necessary.

An image processing facility 104 may convert the two-dimensional image of the surface of the foot into a three-dimensional model of the foot. The image processing facility 104 may obtain the three-dimensional map by measuring the color and/or intensity of a pixel of the two-dimensional image and assigning the pixel a distance from the scanner based on its color and/or intensity. For example, the two-dimensional image may be monochromatic and each pixel may correspond to a shade of gray along a grayscale. In another embodiment, the two-dimensional image may be polychromatic and each pixel may correspond to a color. Each shade of gray or each color may correspond to a particular distance from the surface of the scanner. The image processing facility 104 may process each pixel in the image by assigning each pixel a distance from the scanner, The correspondence between color/shade of gray and distance from the scanner may be empirically derived. Once the pixels in the image are processed, the distances obtained may be used to construct a three-dimensional map of the imaged surface of the foot. The maps may be rotated in 360 degrees, zoomed, displayed in full screen, and displayed in at least one of wire frame, solid, textured, surface and topographical views on a graphical user interface of the image processing facility. The map may be magnified to enable the viewing of a particular foot abnormality or pathology. Image processing may be enabled by CAD/CAM technology.

Foot parameters may be derived from the three-dimensional map. For example, at least one of the height, length, curvature, and position of the arch may be determined from the three-dimensional map. In another example, at least one of the width, curvature, shape, and size of the heel may be determined from the three-dimensional map. A support device design facility 108 may be used to design a support device based on the foot parameters from the three-dimensional map, such as arch height, heel shape and heel size. Other parameters may also be used in the design of the support device, such as foot size, width, user weight, user gender, age, health concerns, and the like. The support device design facility 108 may generate a custom design for a support device based on at least one parameter.

The support device design facility 108 may be adapted to modify the support device design based at least in part on a foot abnormality. For example, a diabetic user may have a sore on a plantar surface of her foot. The dimensions and position of the sore may be determined from the three-dimensional map. In the example, the support device may be designed with a void at the position of the sore. Other modifications to the support device due to other foot abnormalities or pathologies are contemplated and are encompassed herein.

The shape acquisition system 100 may comprise an electronic patient record database 114 for storing the two-dimensional image and the three-dimensional model in association with patient demographics and the custom design. The electronic patient record database 114 allows users to maintain an ongoing log of patient scans, tracking progress throughout the treatment process. The scans may be saved for later use or printed, optionally with patient information.

The shape acquisition system 100 may provide patient education based on the scan and any abnormalities present on the scan or conditions known to exist, either based on the scan or otherwise indicated. For example, patient education may relate to arch pain, calluses, arthritis, diabetes, heel pain, metatarsalgia, plantar fasciitis, ankle sprains, shin splints, bunions, neuromas, leg length discrepancy, and the like. The shape acquisition system 100 may have the ability to customize the education to the patient or doctor's practice, print the patient education, view in various formats, and the like. For example, the education may include patient education notes and treatment instructions. Patient education may include treatment algorithms. For example, patient education may include animated visuals for the diabetic foot, such as 3D-RX visuals, FLASH animation visuals, HTML visuals, and the like. Patient education may be embodied in video, audio, animation, text, and the like.

In embodiments, the shape acquisition system 100 may be a centerpiece of a multi-lingual education and treatment e-center. In an embodiment, a doctor may mark a diagnosis or course of treatment on the user interface and relevant applications or education modules may be identified based on the diagnosis/treatment.

The user interface may include applications directed at diabetes products, diabetes services, diabetes patient education, and the like.

The shape acquisition system 100 may include a system for engaging in a referral network. For example, once a patient has been scanned and a diagnosis is entered into the system 100, the user may search a referral network to identify a provider for continued care. The search may begin automatically when the diagnosis is entered.

The shape acquisition system 100 may be embodied as a mobile cart, a portable model, a scanner and computer combination such as with a tablet PC, laptop, desktop computer, and the like. The system 100 may operate wirelessly, such as to update a database 114, automatically detect and transparently install any necessary software updates, wirelessly transmit diagnosis, treatment information, scans, etc. to a patient records facility or a milling facility, and the like.

The design may be ordered as a support device by uploading the design as an electronic order to a support device fabrication facility 110 for fabrication of the support device based on the support device design generated by the support device design facility 108. Fabrication of the support device may commence from a support device template or may commence de novo from starting materials. The user may have the ability to add notes to each product ordered, place an order on hold, select multiple products, change product options after selecting the product, view orders in a shopping cart environment, delete orders before finalizing orders, view each product ordered and print details, place the order on rush, ship the order directly to the patient, ship the order to an alternate address, rush the shipment, display a number of items in a shopping cart, display a quick reference of items ordered on the main screen, edit order after submission, and the like. The system 100 may include a “Favorites” or Preset Button for default orders. The electronic order may include information regarding the patient's diagnosis. A facility may enable converting a patient summary screen into PDF for patient records.

The design may also be uploaded to a shoe selection facility 112 for selecting a shoe that can accommodate the support device.

The shape acquisition system 100 may include a practice management module 118. The practice management module 118 may further include a scheduling module, an e-claims module, an insurance verification facility, and the like.

The shape acquisition system 100 may include a charting module 120. The charting module 120 may enable a user to take a patient history, create pressure mapping tracking/graphs, create temperature sensor tracking/graphs, and the like.

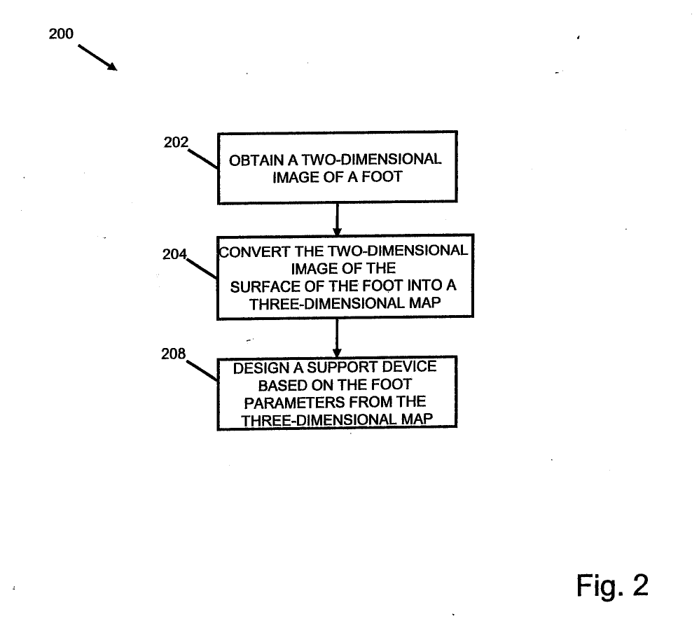

Referring to FIG. 2, a method for designing a support device for a foot may include obtaining a two-dimensional image of the surface of a foot 202; converting the two-dimensional image of the surface of the foot into a three-dimensional map 204; and designing a support device based on the foot parameters from the three-dimensional map 208. The design may be at least partially based on a foot abnormality. The design may be at least partially based on a foot abnormality. Converting the two-dimensional image to a three-dimensional map may include measuring the color and/or intensity of a pixel of the two-dimensional image and assigning the pixel a distance from the scanner based on its color and/or intensity. The pixel may be a color or grayscale pixel. The method may further include fabricating the support device based on the support device design.

In an embodiment, the shape acquisition system 100 may also be integrated with a patient administration system, patient management technology, patient retention technology, patient communication technology, and a digital patient records facility.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

The invention claimed is:

1. A system for designing a support device for a foot, comprising:
a scanner that obtains a two-dimensional image of the surface of a foot;
an image processing facility that converts the two-dimensional image of the surface of the foot into a three-dimensional map; and
a support device design facility that designs a support device based on the foot parameters from the three-dimensional map.

2. The system of claim 1, wherein the support device design facility is adapted to modify the support device design based at least in part on a foot abnormality.

3. The system of claim 1, wherein the image processing facility obtains the three-dimensional map by measuring the color and/or intensity of a pixel of the two-dimensional image and assigning the pixel a distance from the scanner based on its color and/or intensity.

4. The system of claim 3, wherein the pixel is a grayscale pixel.

5. The system of claim 3, wherein the pixel is a color pixel.

6. The system of claim 1, further comprising, a support device fabrication facility that fabricates the support device based on the support device design generated by the support device design facility.

7. A method for designing a support device for a foot, comprising:
obtaining a two-dimensional image of the surface of a foot;
converting the two-dimensional image of the surface of the foot into a three-dimensional map; and
designing a support device based on the foot parameters from the three-dimensional map.

8. The method of claim 7, wherein designing the support device comprises modifying the support device design based at least in part on a foot abnormality.

9. The method of claim 7, wherein converting the two-dimensional image to a three-dimensional map comprises measuring the color of a pixel of the two-dimensional image and assigning the pixel a distance from the scanner based on its color.

10. The method of claim 7, wherein the pixel is a grayscale pixel.

11. The method of claim 7, wherein the pixel is a color pixel.

12. The method of claim 7, further comprising, fabricating the support device based on the support device design.
